(19) United States
(12) Patent Application Publication
(10) Pub. No.: US 2013/0128598 A1
(43) Pub. Date: May 23, 2013

(54) PORTABLE COMPUTER

(71) Applicant: Wen-Ching Liao, New Taipei City (TW)

(72) Inventor: Wen-Ching Liao, New Taipei City (TW)

(21) Appl. No.: 13/541,575

(22) Filed: Jul. 3, 2012

(30) Foreign Application Priority Data
Nov. 21, 2011 (TW) 100142600

(51) Int. Cl. F21V 21/30

(52) U.S. Cl. 362/428

(57) ABSTRACT

A portable computer is disclosed, wherein the portable computer includes a display, an illumination device, a main body, and a driving device. The main body is pivotally connected to the display. The illumination device is disposed in the display. The driving device disposed in the display and connected to the illumination device is used for driving the illumination device to rotate.

### BACKGROUND OF THE INVENTION

1. Field of the Invention

The present invention relates to a portable computer; more particularly, the present invention relates to a portable computer with an illumination device.

2. Description of the Related Art

An illumination device disposed on a notebook computer is usually used for illuminating the keyboard and also used as a light source for the display screen. This kind of illumination device is usually disposed above the display screen and cannot rotate relative to the display screen. As a result, the effective illumination area of the illumination device is limited. Therefore, when a user rotates the display screen, the illumination device cannot accurately illuminate the keyboard every time because of the fixed angle between the display screen and the main body of the notebook computer. If the light source from the environment is inadequate, the user must find an alternative light source to illuminate the keyboard, which is not convenient for the user.

Therefore, there is a need to provide a new portable computer, wherein the illuminating angle of the illumination device can change according to the angle of rotation of the display such that the illumination device can accurately illuminate the keyboard while the portable computer is in use to solve the problem of the prior art.

### SUMMARY OF THE INVENTION

It is an object of the present invention to provide a portable computer with an illumination device, wherein the direction of illumination of the illumination device can be changed according to the angle of rotation of the display.

To achieve the abovementioned object, the portable computer of the present invention comprises a display, an illumination device, a main body, and a driving device. The main body is pivotally connected to the display. The illumination device is disposed in the display. The driving device disposed in the display and connected to the illumination device for driving the illumination device to rotate.

Via the portable computer of the present invention, the illumination device can rotate according to the position of the display relative to the main body to provide a light source for the keyboard of the portable computer.

### BRIEF DESCRIPTION OF THE DRAWINGS

FIG. 1 illustrates a first schematic drawing of the portable computer of one embodiment of the present invention.

FIG. 2 illustrates a second schematic drawing of the portable computer of one embodiment of the present invention.

FIG. 3 illustrates the hardware structure of the portable computer of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

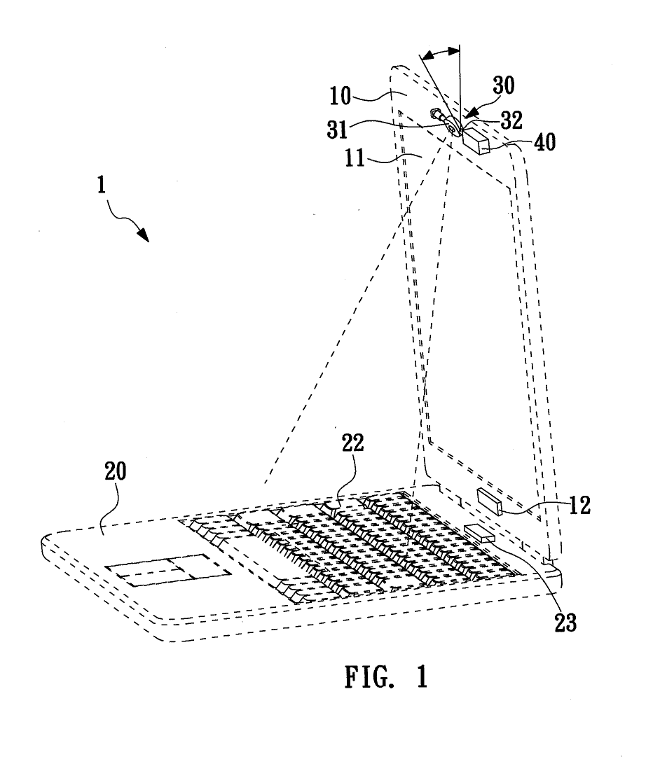

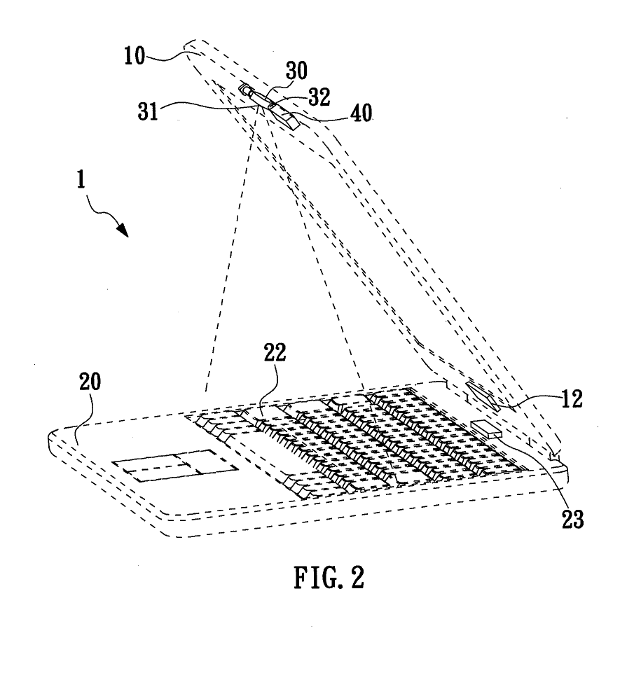

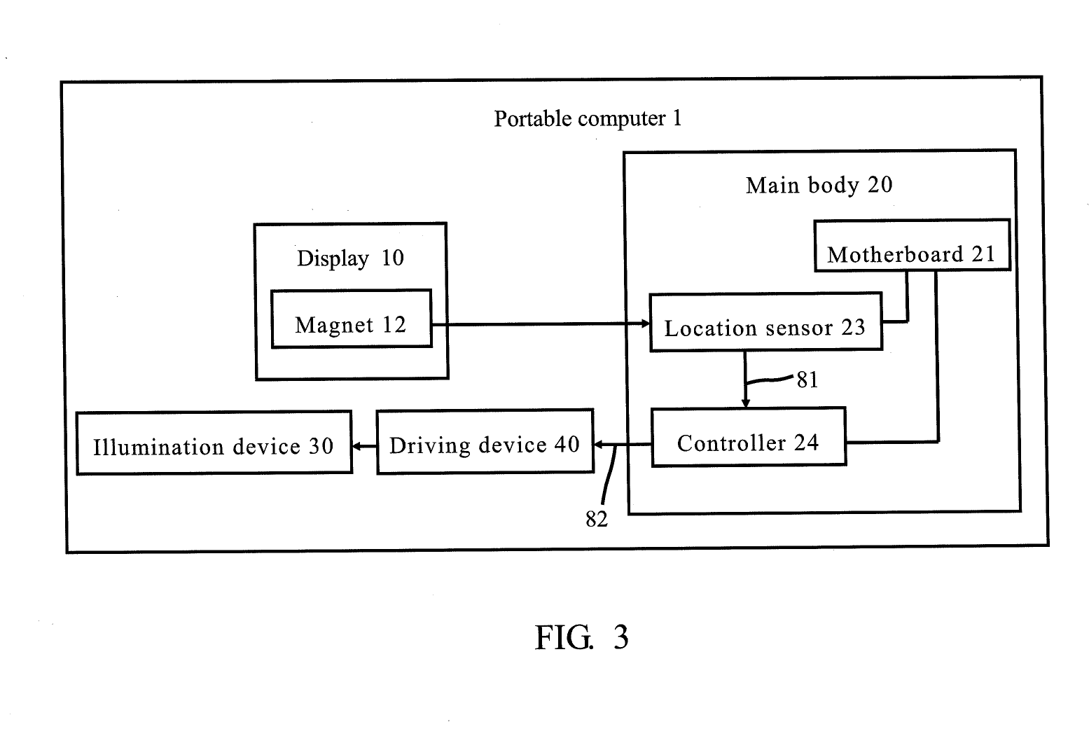

Please refer to FIG. 1 to FIG. 3 for the portable computer of one embodiment of the present invention. FIG. 1 illustrates the first schematic drawing of the portable computer of one embodiment of the present invention. FIG. 2 illustrates the second schematic drawing of the portable computer of one embodiment of the present invention. FIG. 3 illustrates the hardware structure of the portable computer of the present invention.

As shown in FIG. 1 and FIG. 2, the portable computer 1 of the present invention comprises a display 10, a main body 20, an illumination device 30, and a driving device 40, wherein the main body 20 is pivotally connected to the display 10 for allowing the display 10 to rotate relative to the main body 20. The illumination device 30 and the driving device 40 are disposed in the display 10. The driving device 40 is connected to the illumination device 30, and the driving device 40 is used for driving the illumination device 30 to rotate relative to the display 10.

According to one embodiment of the present invention, as shown in FIG. 1 and FIG. 2, the display 10 further comprises a display screen 11 and a magnet 12, wherein the magnet 12 of the embodiment is located beneath the display screen 11, and the illumination device 30 and the driving device 40 are located above the display screen 11, but the present invention is not limited to the abovementioned embodiment; the relative positions of the abovementioned elements can be changed.

As shown in FIG. 1 and FIG. 3, the main body 20 of the portable computer 1 comprises a motherboard 21, a keyboard 22, a location sensor 23, and a controller 24, wherein the position of the location sensor 23 is opposite to the magnet 12. The location sensor 23 of the portable computer 1 is used for sensing the position of the display 10 relative to the main body 20, and generating a position signal 81 according to the relative position. The controller 24 is electrically connected to the location sensor 23. The controller 24 delivers a rotating signal 82 to the driving device 40 according to the position signal 81, and the driving device 40 drives the illumination device 30 to rotate according to the rotating signal 82. According to one embodiment of the present invention, the location sensor 23 and the controller 24 are disposed on the motherboard 21.

As shown in FIG. 1 and FIG. 2, the illumination device 30 further comprises an illuminating main body 31 and a rotating shaft 32; the illuminating main body 31 is connected to the rotating shaft 32, the driving device 40 is connected to the rotating shaft 32, and the driving device 40 drives the illuminating main body 31 to rotate via the rotating shaft 32. It is to be understood that, according to one embodiment of the present invention, in order to drive the driving device 40, the power supply of the motherboard 21 provides the electric power of 24V to the driving device 40 to rotate the illumination device 30. According to one embodiment of the present invention, the portable computer 1 of the present invention is a notebook computer, the location sensor 23 is a Hall sensor, the controller 24 is a closed loop controller, the driving device 40 is a motor, and the illuminating main body 31 is a light emitting diode, but the present invention is not limited to the abovementioned embodiment.

In the present embodiment, as shown in FIG. 1 and FIG. 2, the location sensor 23 is used for sensing the magnetic field strength of the magnet 12 to determine the position of the display 10 relative to the main body 20; the relative position of the present embodiment represents the angle between the display 10 and the main body 20. The controller 24 is electrically connected to the location sensor 23 and the driving device 40. When an angle is formed between the display 10 and the main body 20, the controller 24 can calculate an angle of rotation for the illumination device 30 to rotate to illuminate the keyboard 22 according to the angle. It is to be understood that the portable computer 1 of the present embodiment of the present invention has already stored a table of the magnetic field strength and the corresponding angle which lists various magnetic field strengths and each of the corresponding angles between the display 10 and the main body 20 under different magnetic field strengths. The table is employed as a foundation for determining the relative position between the display 10 and the main body 20. The table of the magnetic field strengths and the corresponding angles is made in advance by technical staff through experimental measurements to obtain the different magnetic field strengths sensed by the location sensor 23 when the corresponding angle is formed by the display 10 and the main body 20.

Taking FIG. 1 as an example, assuming that the relative position of the display 10 to the main body 20 as shown in FIG. 1, the location sensor 23 senses that the magnetic field strength of the magnet 11 is 0.5 mG (milligauss). The location sensor 23 determines the corresponding angle between the display 10 and the main body 20 when the magnetic field strength is 0.5 mG via the table of the magnetic field strength and the angles and generates the position signal 81. The position signal 81 is delivered to the controller 24. The controller 24 calculates the angle of rotation for the illumination device 30 to rotate relative to the display 10 according to the position signal 81 and then generates the rotating signal 82. The rotating signal 82 is delivered to the driving device 40 by the controller 24 according to the position signal 81 for driving the illumination device 30 to rotate; as a result, the light source for the keyboard 22 is provided. It is to be understood that the method of the abovementioned embodiment is only for illustration; the present invention is not limited to that design. For example, a table of the magnetic field strengths and angles of rotation can be formed directly; therefore, the angle of rotation can be determined via the table of the magnetic field strengths and angles of rotation. It is suggested that the abovementioned value be obtained or calculated via software. However, it is to be understood that among the various implementation methods of the present invention, preparing a table in advance is only one of the possible implementation methods for determining the angle between the display 10 and the main body 20; thus, the present invention is not limited to that design.

It is to be understood, according to the common practice of users, that the angle between the display 10 and the main body 20 is usually 90°±30°; therefore, the illumination device 30 of the present invention can rotate relative to the display 10 for ±30°, to offset the angle of rotation of the display 10, allowing the illumination device 30 to accurately illuminate the keyboard 22 to solve the problem of the prior art that the illumination device cannot rotate with the display screen and thus the keyboard 22 cannot be illuminated accurately.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A portable computer comprising:
a display;
a main body pivotally connected to the display;
an illumination device disposed in the display; and
a driving device disposed in the display and connected to the illumination device, the driving device is used for driving the illumination device to rotate.

2. The portable computer as claimed in claim 1, wherein the main body further comprises a location sensor for sensing a relative position between the main body and the display and generating a position signal according to the relative position.

3. The portable computer as claimed in claim 2, wherein the main body further comprises a controller electrically connected to the location sensor; the controller delivers a rotating signal to the driving device according to the position signal.

4. The portable computer as claimed in claim 3, wherein the display comprises a magnet opposite to the location sensor.

5. The portable computer as claimed in claim 4, wherein the location sensor detects the magnetic field strength of the magnet to determine the relative position between the display and the main body.

6. The portable computer as claimed in claim 5, wherein the display comprises a display screen; the illumination device and the driving device are located on the display screen.

7. The portable computer as claimed in claim 6, wherein the magnet is located beneath the display screen.

8. The portable computer as claimed in claim 7, wherein the illumination device further comprises an illuminating main body and a rotating shaft; the illuminating main body is connected to the rotating shaft; the driving device is connected to the rotating shaft; the driving device drives the illuminating main body to rotate via the rotating shaft.

9. The portable computer as claimed in claim 8, wherein the location sensor is a Hall sensor and the controller is a closed loop controller.

10. The portable computer as claimed in claim 9, wherein the driving device is a motor and the illuminating main body is a light emitting diode.
